(19) United States
(12) Patent Application Publication
(10) Pub. No.: US 2008/0006503 A1
(43) Pub. Date: Jan. 10, 2008

(54) SHIFTING ELEMENT ARRANGEMENT

(75) Inventors: Gabor Diosi, Friedrichshafen (DE); Josef Haupt, Tettnang (DE); Martin Brehmer, Konstanz (DE)

Correspondence Address: DAVIS BUJOLD & Daniels, P.L.L.C., 112 PLEASANT STREET, CONCORD, NH, 03301, US

(73) Assignee: ZF Friedrichshafen AG, Friedrichshafen (DE)

(21) Appl. No.: 11/775,343

(22) Filed: Jul. 10, 2007

(30) Foreign Application Priority Data
Jul. 10, 2006 (DE) 102006031788.2

(51) Int. Cl. F16D 13/14; F16D 11/00

(52) U.S. Cl. 192/76; 192/107 T; 192/71; 192/87.1

(57) ABSTRACT

The invention relates to a shifting element arrangement comprising a cylinder (12) of a first clutch (10), the cylinder being configured as a disk carrier, and a cylinder (23) of a second shifting element (20), the cylinder being configured as a disk carrier or band brake cylinder, wherein the cylinder (12) of the first shifting element (10) comprises a hub driveably mounted on a shaft (40) or on a housing, and wherein the cylinder (23) of the second shifting element (20) radially encompasses the cylinder (12) of the first shifting element (10). Instead of mounting the cylinder (23) of the second shifting element (20) to the hub (15) of the cylinder (12) of the first shifting element (10), it is provided that the cylinder (23) of the second shifting element (20) is rotatably mounted on the outside diameter of the cylinder (12) of the first shifting element (10) by way of a radial bearing (30).

This application claims priority from German Application Serial No. 10 2006 031 788.2 filed Jul. 10, 2006.

### FIELD OF THE INVENTION

The invention relates to a shifting element arrangement comprising a cylinder of a first shifting element, the cylinder being configured as a disk carrier, and a cylinder of a second shifting element, the cylinder being configured as a disk carrier or band brake cylinder.

### BACKGROUND OF THE INVENTION

Arrangements with two adjoining clutches, wherein a cylindrical disk carrier of the first clutch is arranged, from a spatial perspective, within a cylinder chamber of a cylindrical disk carrier of the second clutch, and a hub of the aforementioned disk carrier of the first clutch is mounted rotatably on a shaft or on a housing, are widely known from transmission production. In general, the aforementioned disk carrier of the second clutch has a hub, which is mounted rotatably either on the hub of the aforementioned disk carrier of the first clutch or on the housing or on the same shaft as the hub of the aforementioned disk carrier of the first clutch or on a further shaft of the transmission. A corresponding example is known, for example, from German patent DE 102 10 348 A1.

The present invention is therefore based upon the objective of creating a shifting element arrangement comprising a cylinder of a first shifting element. The cylinder is configured as a disk carrier and comprises a hub driveably mounted on a shaft or on a housing. A cylinder of a second shifting element is configured as a disk carrier or band brake cylinder and radially encompassing the cylinder of the first shifting element, as well as being mounted rotatably on the cylinder of the first shifting element, wherein the cylinder of the second shifting element is optimized with respect to its producibility.

### SUMMARY OF THE INVENTION

Starting from the known state of the art, the shifting element arrangement comprises a cylinder of a first shifting element. The cylinder is configured as a disk carrier. A cylinder of a second shifting element is configured as a disk carrier or band brake cylinder, wherein the cylinder of the first shifting element has a hub driveably mounted on a shaft or on a housing and wherein the cylinder of the second shifting element radially encompasses the cylinder of the first shifting element.

Unlike the representative state of the art, according to which the cylinder of the (radially outer) second shifting element has a hub which, in turn, is mounted rotatably on the hub of the cylinder of the (radially inner) first shifting element, rotatably mounting the cylinder of the (radially outer) second shifting element on the outside diameter of the cylinder of the (radially inner) first shifting element is provided in accordance with the invention.

The radial bearing, provided between the outside diameter of the cylinder of the (radially inner) first shifting element and an inside diameter of the cylinder of the (radially outer) second shifting element, can optionally have a torsion-resistant connection to the cylinder of the first shifting element or to the cylinder of the second shifting element.

In a preferred constructional embodiment, it is proposed that the radial bearing is configured as a sleeve bearing with bearing segments disposed separately from one another around the circumference. It is preferable if at least three of these bearing segments, which can also be referred to as sliding pads, are provided. An expanding pin fastening device may be provided, for example, so as to fasten these bearing segments to the cylinder of the first or second shifting element, whereby the bearing segments are clipped into apertures or bores of the corresponding shifting element cylinder, the apertures or bores corresponding to the respective bearing segment.

In a further design embodiment, it is proposed to configure the radial bearing as an annular sleeve bearing.

As far as the material is concerned, the radial bearing, for example, can be made essentially of plastic or essentially of bearing metal.

### BRIEF DESCRIPTION OF THE DRAWINGS

The invention will now be described, by way of example, with reference to the accompanying drawings in which:

FIG. 1 is an axial section of a transmission according to the state of the art;

FIG. 2 is a sectional axial section of a transmission comprising an exemplary shifting element arrangement according to the invention;

FIG. 3 is an enlarged section, according to FIG. 2, in the region of the radial bearing according to the invention, and

FIG. 4 is an enlarged radial section, according to FIG. 2, in the region of the radial bearing according to the invention.

### DETAILED DESCRIPTION OF THE INVENTION

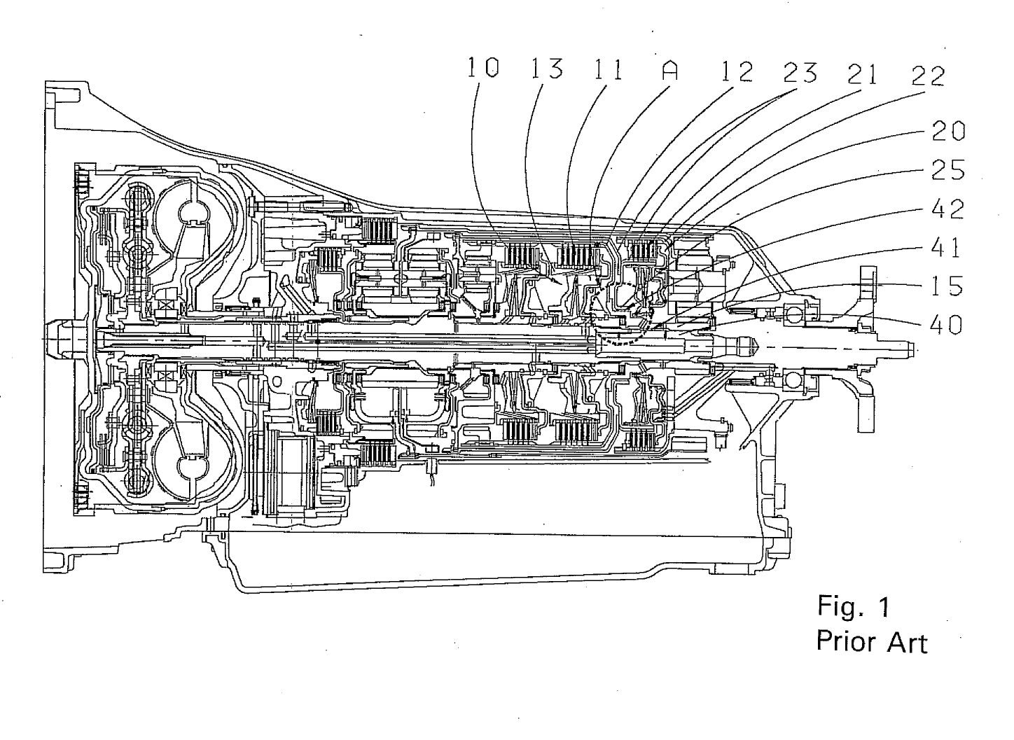

The transmission section shown, according to FIG. 1, as an example of the state of the art discloses, a shifting element arrangement with a first clutch 10 and a second clutch 20. The first cluch 10 comprises a clutch pack 11, a cylinder 12 configured as an outside disk carrier for receiving disks with external teeth of this clutch pack 11 as well as a cylindrical inside disk carrier 13 for receiving disks with internal teeth of this clutch pack 11. A hub 15 of this cylinder 12 or outside disk carrier of the first clutch 10 is mounted radially on a shaft 40 of the transmission and can be rotated via a bearing 41. The second clutch 20 comprises a clutch pack 21, a cylinder 23 configured as an inside disk carrier for receiving disks with interior teeth of this clutch pack 21 as well as cylindrical outside disk carrier 22 for receiving disks with exterior teeth of this clutch pack 21, whereby the first clutch 10, from a spatial perspective, is arranged entirely within a cylinder chamber formed by this cylinder 23 or inside disk carrier of the second clutch 20. As is apparent from the detail identified by A, the cylinder 23 or inside disk carrier of the second clutch 20 has a hub 25, which is mounted radially on the hub 15 of the cylinder 12 or outside disk carrier of the first clutch 10 and can be rotated via a bearing 42. Since the clutch packs 11, 21 of the two clutches are, on one hand, from a spatial perspective, arranged axially adjacent to each other, and the hub 25 of the cylinder 23 or inside disk carrier of the second clutch 20, viewed from a spatial perspective, is arranged approximately radially under the clutch pack 21 of the second clutch 20 and, on the other hand, a section of the cylinder 23 or inside disk carrier of the second clutch 20 radially encompasses the clutch pack 11 of the first clutch 10, the cylinder 23 or inside disk carrier of the second clutch 20 is configured as a two-piece welded construction.

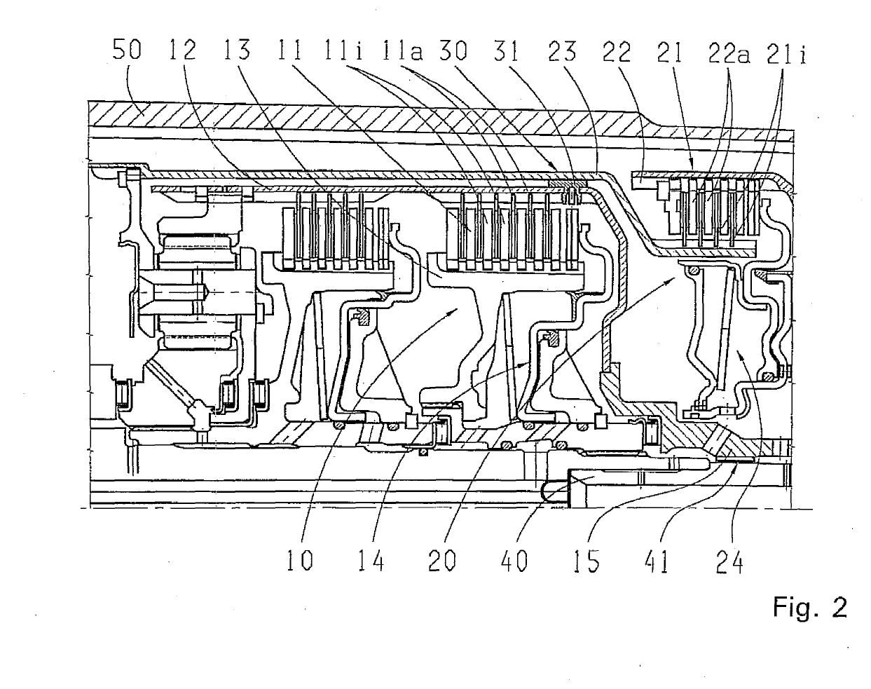

FIG. 2 shows an exemplary shifting element arrangement according to the invention, comprising a first shifting element 10, which is configured by way of example as a multi-disk clutch, and a second shifting element 20, which is configured by way of example likewise as a multi-disk clutch. Both are arranged inside a transmission housing 50. Similar to the state of the art according to FIG. 1, the first shifting element 10, according to FIG. 2, comprises a cylinder 12 which, by way of example, is configured as an outside disk carrier for receiving disks 11a with exterior teeth of the clutch pack 11 of the first shifting element 10. Here the cylinder 12 or outside disk carrier of the first shifting element 10 has a hub 15, which is mounted rotatably on a shaft 40 of the transmission by way of a bearing 41. A cylindrical inside disk carrier of the first shifting element 10 is designated with reference numeral 13. The carrier is provided to receive disks 11i with interior teeth of the clutch pack 11. A servo device of the first shifting element 10, for actuating the clutch pack 11, is designated with reference numeral 14.

Furthermore, FIG. 2 shows that the second shifting element 20 has a cylinder 23 which, by way of example, is configured as an inside disk carrier for receiving disks 21i with interior teeth of a clutch pack 21 of the second shifting element 20. The cylinder 23 of the second shifting element 20 substantially encompasses the first shifting element 10, wherein the clutch pack 21 of the second shifting element 20 is, viewed from a spatial perspective, arranged axially adjacent to the clutch pack 11 of the first shifting element 10. A cylindrical outside disk carrier of the second shifting element 20 is designated with reference numeral 22. The carrier is provided to receive disks 11a with exterior teeth of the clutch pack 21. A servo device of the second shifting element 20, for actuating the clutch packs 21, is designated with reference numeral 24.

Unlike the state of the art according to FIG. 1, according to FIG. 2, it is provided that the cylinder 23 of the second shifting element 20 is mounted on the outside diameter of the cylinder 12 (disposed radially inside this cylinder 23) of the first shifting element 10 by way of a radial bearing 30. In this way, the hub of the (radially outer) cylinder 23 of the second shifting element 20 provided is eliminated, according to the state of the art. The cylinder 23 or inside disk carrier of the second shifting element 20 is, therefore, accordingly easy to produce, for example as a single-piece deep-drawn sheet metal component.

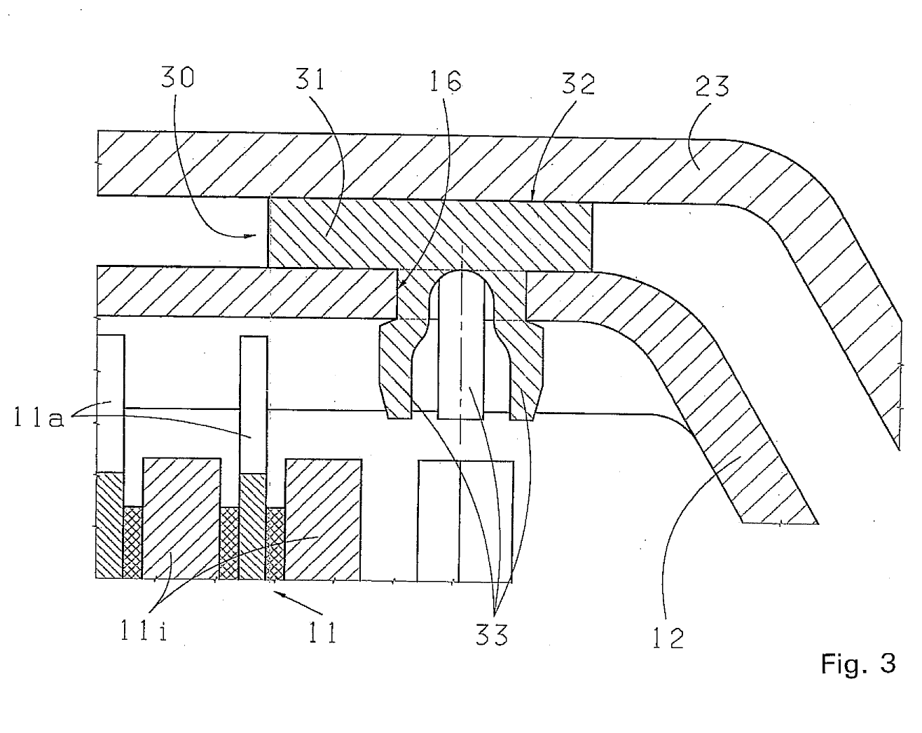

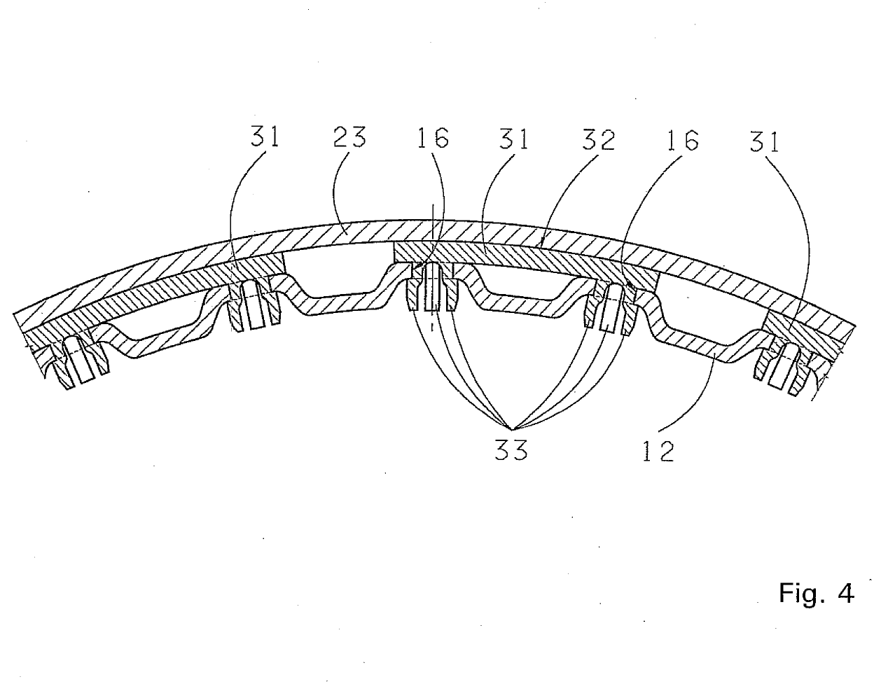

In the exemplary embodiment according to FIG. 2, this inventive radial bearing 30 is arranged between the outside diameter of the cylinder 12 of the first shifting element 10 and an inside diameter of the cylinder 23 of the second shifting element 20, from a spatial perspective, close to the clutch pack 11 of the first shifting element 10. It has a torsion-resistant connection, via expanding pins, to the (radially inner) cylinder 12 and configured, by way of example, as a pad bearing, which will be explained in more detail hereinafter with reference to FIG. 3 and FIG. 4. Of course, in another design embodiment, it may be provided that the radial bearing, provided between the outside diameter of the cylinder 12 of the first shifting element 10 and the inside diameter of the cylinder 23 of the second shifting element 20, has a torsion-resistant connection to the (radially outer) cylinder 23. In a further design embodiment, it may also be provided that the radial bearing, provided between the outside diameter of the cylinder 12 of the first shifting element 10 and the inside diameter of the cylinder 23 of the second shifting element 20, is configured as an annular sleeve bearing (without or also with open edge). Plastic or bearing metal, for example, can be provided as the material for the radial bearing 30.

FIG. 3 shows an enlarged section from FIG. 2, in the region of the inventive radial bearing 30. As in FIG. 2, the cylinder (arranged radially on the inside with respect to the inventive shifting element arrangement) of the first shifting element 10, which in this example is configured as an outside disk carrier, in the cylinder chamber of which the clutch pack 11 of the first shifting element 10 is disposed, is identified by reference numeral 12. The disks 11a with exterior teeth of the clutch pack 11, the disk positively engaging a corresponding catch profile of the cylinder 12 or outside disk carrier of the first shifting element 10, are configured, by way of example as steel disks, the disks 11i with interior teeth of this clutch pack 11 are configured, by way of example, as lining disks. As in FIG. 2, the cylinder (arranged radially on the outside with respect to the inventive shifting element arrangement) of the second shifting element 20 is designated with reference numeral 23.

The radial bearing 30 of the invention which, by way of example, is configured as a sleeve bearing with bearing segments 31 arranged separately from one another across the circumference, is provided radially between the outside diameter of the radially inner cylinder 12 and the inside diameter of the radially outer cylinder 23. So as to connect the individual bearing segments 31 torsion-resistant on the radially inner cylinder 12, this cylinder 12 on the radially outer jacket surface thereof comprises bores or apertures 16 distributed around the circumference, the bores or apertures corresponding to the respective bearing segment 31. The individual bearing segments 31 on the inside diameter thereof, have expanding pins 33 which, during the assembly of the individual bearing segments 31 on the radially inner cylinders 12, are clipped into the bores or apertures 16 of the cylinder 12. The sliding surface of the radial bearing 30 or the individual bearing segments 31 is identified with reference numeral 32. If the two cylinders 12, 23 rotate at different speeds, a relative movement occurs between the outside diameter of the bearing segments 31 and the inside diameter of the radially outer cylinder 23.

FIG. 4 shows an enlarged radial section in the region of the inventive radial bearing according to FIG. 2. As in FIG. 2, the cylinder disposed radially on the inside, with respect to the inventive shifting element arrangement, is identified with reference numeral 12 and the cylinder disposed radially on the outside, with respect to the inventive shifting element arrangement, is identified with reference numeral 23. Easily apparent is the catch profile of the radially inner cylinder 12, which forms the outside disk carrier of the first shifting element 10, for the disks 11a with exterior teeth (not visible here) of the clutch pack 11 of the first shifting element 10. The inventive radial bearing 30 which, by way of example, is configured as a sleeve bearing with bearing segments 31 disposed separately from one another around the circumference, is provided radially between the outside diameter of the radially inner cylinder 12 and the inside diameter of the radially outer cylinder 23. As is furthermore apparent according to FIG. 4, in the illustrated example, each of these bearing segments 31 has two expanding pin connections 33 for being positively fixed to the radially inner cylinder 12.

If necessary, the person skilled in the art will modify this attachment of the bearing segments 31, for example, by using only one expanding pin per bearing segment or by using more than two expanding pins per bearing segment or by using another suitable positive connection or by a suitable non-positive connection, such as a glued connection or by a suitable bonded connection. Likewise, the person skilled in the art will adapt the quantity and shape, as well as the material of the bearing segments of the inventive radial bearing. to the actual conditions, in particular while considering actually occurring bearing loads and environmental parameters, for example sliding speed, radial load, ambient temperature, lubricant temperature and lubricant quantity.

The present invention is, of course, not limited to the exemplary embodiment described with reference to the Figures. Just as the design modifications of the inventive radial bearings, also other shifting element arrangements, according to which brakes are, for example, provided in place of clutches or according to which the (radially inner) cylinder of the first shifting element is not mounted on a shaft, but on a housing element or according to which the friction elements of the two shifting elements have a different position in relation to one another from a spatial perspective, fall under the scope of the protection of the present invention.

### REFERENCE NUMERALS

10 first shifting element, first clutch
11 clutch pack of the first shifting element
11a outer disks of the first shifting element, lining disks
11i inner disks of the first shifting element, steel disks
12 cylinder, outside disk carrier of the first shifting element
13 inside disk carrier of the first shifting element
14 servo device of the first shifting element
15 hub of the cylinder of the first shifting element
16 bore of the outside disk carrier
20 second shifting element, second clutch
21 clutch pack of the second shifting element
21a outer disks of the first shifting element, steel disks
21i inner disks of the first shifting element, lining disks
22 outer clutch pack of the second shifting element
23 cylinder, inside disk carrier of the second shifting element
24 servo device of the second shifting element
25 hub of the cylinder of the second shifting element
30 radial bearing, sleeve bearing
31 bearing segment
32 sliding surface
33 expanding pin
40 shaft
41 bearing
42 bearing
50 housing
A details of the transmission section

1-13. (canceled)

14. A shifting element arrangement comprising a cylinder (12) of a first shifting element (10), the cylinder of the first shifting element (10) being configured as a disk carrier, and a cylinder (23) of a second shifting element (20), the cylinder of the second shifting element (20) being configured as one of a disk carrier and band brake cylinder, the cylinder (12) of the first shifting element (10) comprising a hub (15) driveably mounted on one of a shaft (40) and a housing, and the cylinder (23) of the second shifting element (20) at least substantially radially encompassing the cylinder (12) of the first shifting element (10);
wherein the cylinder (23) of the second shifting element (20) is rotatably mounted on an outside diameter of the cylinder (12) of the first shifting element (10).

15. The shifting element arrangement according to claim 14, wherein a radial bearing (30) is provided between the outside diameter of the cylinder (12) of the first shifting element (10) and an inside diameter of the cylinder (23) of the second shifting element (20), and the radial bearing has a torsion-resistant connection to the cylinder (12) of the first shifting element (10).

16. The shifting element arrangement according to claim 14, wherein a radial bearing is provided between the outside diameter of the cylinder of the first shifting element and an inside diameter of the cylinder of the second shifting element, the radial bearing has a torsion-resistant connection to the cylinder of the second shifting element.

17. The shifting element arrangement according to claim 14, wherein the radial bearing (30) is a sleeve bearing with bearing segments (31) disposed separately from one another around a circumference of the cylinder (12) of the first shifting element (10).

18. The shifting element arrangement according to claim 17, wherein the bearing segments (31) are clipped in on of apertures and bores (16) of one of the cylinder (12) of the first shifting element (10) and the second shifting element (20), and the apertures or bores corresponding to the respective bearing segment (31).

19. The shifting element arrangement according to claim 14, wherein the radial bearing (30) is an annular sleeve bearing.

20. The shifting element arrangement according to claims 14, wherein the cylinder (12) of the first shifting element (10) is an outside disk carrier for receiving disks, of a clutch pack (11) of the first shifting element (10), which have exterior teeth.

21. The shifting element arrangement according to claim 14, wherein the cylinder (23) of the second shifting element (20) is an inside disk carrier for receiving disks, of a clutch pack (21) of the second shifting element (20), which have interior teeth.

22. The shifting element arrangement according to claim 20, wherein the clutch packs (11, 21) of the first and the second shifting elements (10, 20) are disposed, from a spatial perspective, axially adjacent to one another.

23. The shifting element arrangement according to claim 20, wherein the clutch pack of the second shifting element (20) is disposed, from a spatial perspective, at least in part radially over the clutch pack of the first shifting element (10).

24. The shifting element arrangement according to claim 14, wherein the radial bearing (30) is disposed, from a spatial perspective, close to the clutch pack (11) of the first shifting element (10).

25. The shifting element according to claim 14, wherein the radial bearing (30) is made substantially from a plastic material.

26. The shifting element according to claim 14, wherein the radial bearing (30) is made substantially from a bearing metal.

27. The shifting element arrangement according to claim 15, wherein the torsion-resistant connection is one of a form-locking connection, a tensional connection and a substance-locking connection.

28. The shifting element arrangement according to claim 16, wherein the torsion-resistant connection is one of a form-locking connection, a tensional connection and a substance-locking connection.
